(19) United States
(12) Patent Application Publication
(10) Pub. No.: US 2026/0064737 A1
(43) Pub. Date: Mar. 5, 2026

(54) ARTIFICIAL INTELLIGENCE BASED SYSTEM FOR IDENTIFYING DOMAIN SPECIFIC CONTEXTUAL INFORMATION WITHIN AN ENTERPRISE COMPUTING ENVIRONMENT

(71) Applicant: LIFEX TECHNOLOGIES INDIA PRIVATE LIMITED, BANGALORE (IN)

(72) Inventors: Naveen Prabhu, Bangalore (IN); Harish Gnanasekar, Bangalore (IN); Arjun V Shenoy, Bangalore (IN)

(21) Appl. No.: 19/477,689

(22) PCT Filed: Apr. 27, 2023
(86) PCT No.: PCT/IN2023/050412

§ 371 Date: Oct. 22, 2025

(30) Foreign Application Priority Data
Apr. 27, 2022 (IN) 202241024839

(51) Int. Cl. G06F 16/3332; G06F 16/332

(52) U.S. Cl. CPC G06F 16/3334; G06F 16/3322

(57) ABSTRACT

The present disclosure provides a system and method for identifying domain specific contextual information with an enterprise computing environment. The system is configured to generate a domain specific semantic model (M) based on one or more domain specific articles and assets dataset from web, (ii) generate one or more enterprise specific semantic models for all N organizations by fine tuning the domain specific semantic model with the one or more articles and assets from an enterprise, and (iii) identifying a list of relevant knowledge assets within the enterprise using the one or more enterprise specific semantic models in response to a search query.

### BACKGROUND

### Technical Field

The present disclosure relates generally to data access, and more particularly, the present disclosure relates to an artificial intelligence-based system for identifying domain-specific contextual information within an enterprise computing environment. Moreover, the present disclosure relates to a method for identifying domain-specific contextual information within the enterprise computing environment.

### Description of the Related Art

Problem-solving-based knowledge enterprises like information technology (IT) services, analytics services, artificial intelligence (AI), and management consulting organizations are internally chaotic. The revenue of such organizations depends on the billing of every human resource in their organization. Hence, as a result of trying to maximize revenue and operating margins, human resources are always on billable tasks. As a result, the time available to organize knowledge is less in such organizations. As a result, often, knowledge does not get documented into knowledge assets.

Even if documented, the knowledge assets do not get stored in a manner that is easily discoverable by others in their time of need. Typically, organizations use document storage tools to store and organize knowledge assets and control access to them. These document storage tools provide ways to easily discover these assets in the future. Unfortunately, even with document storage tools, the knowledge assets often remain undiscoverable because storage in folder structures is complex. Different human resources have different ways to create folder structures. Hence, the knowledge assets get lost in these folder structures. Further, when an organization enforces a folder structure, human resources often don't store the knowledge assets because they are unable to use that specific folder structure across all their work. Hence, the knowledge assets end up remaining private and undiscoverable.

Additionally, as the organization grows, they use different documentation tools to document and store knowledge assets. Some tools may work better for certain personas. For example, engineering teams may prefer Atlassian Confluence while sales teams may prefer Microsoft Office. Even if the organization decides to use a single documentation tool, human resources have personal preferences and do not adhere to this decision. All of this creates a distributed system that houses knowledge assets. The ability to find relevant information in this distributed system is a problem.

Accordingly, the reusability of knowledge assets across such organizations is low. This results in rework. Often, it also results in increased timelines to deliver output to customers. Examples of this are large turn-around time to respond to a request for proposals (RFP) or customer requirements and large delivery time on projects that could otherwise have been completed earlier. Due to less reusability of the knowledge assets, the revenue of the organization reduces given that employees are spending time on re-working which in turn causes poor customer experience and increases the burden of the employee as everything needs to be done from scratch.

Some existing approaches provide enterprise search tools that allow for connection to every documentation and document storage tool in the organization and search for relevant information. However, such enterprise search tools are generic tools and built to fit every industry and domain. Hence, they do not take into consideration of domain and industry-specific ontologies or semantics to surface search results. Further, they do not have features that help manage and curate assets, nor do such enterprise search tools provide contextual knowledge insights, or focus on the deep discoverability of certain types of information from certain specific sources, instead they focus on all types of information from all sources.

Some existing approaches provide functional-specific tools that enable the documentation, creation, and discovery of knowledge assets for specific functions. These existing functional-specific tools are focused on specific personas and specific types of organizations. Hence, they are not usable because a lot of features would not be relatable to every domain and industry. Further, due to their specificity, existing functional-specific tools are priced very high. None of these tools focus on professional services companies like IT services, analytics services, AI consulting, and management consulting wherein the uniqueness of the problem lies in the fact that they have large bloated delivery organizations. Further, the assets and documentation systems used may vary significantly from these existing functional-specific tools.

Therefore, there arises a need to address the aforementioned technical drawbacks in existing technologies related to accessing data within a specific domain in an enterprise computing environment.

### SUMMARY

In view of the foregoing, an embodiment herein provides a system for identifying domain-specific contextual information within an enterprise computing environment to recommend a storyboard for creating a new knowledge asset in response to a search query. The system includes an information retrieval server and a central semantic model generating unit. The information retrieval server includes a first memory and a first processor. The first processor executes one or more enterprise-specific semantic models to identify domain-specific contextual information including one or more domain specific articles and assets within an enterprise computing environment in response to a search query received from a user device. The user device is communicatively connected to the information retrieval server through a network. The central semantic model generating unit is communicatively connected to the information retrieval server through a network. The central semantic model generating unit includes a second memory and a second processor. The second processor is configured to (i) pre-process, using a text pre-processor, the one or more domain-specific articles and assets received from the information retrieval server by (a) extracting text or unstructured components from the one or more domain-specific articles and assets, and (b) processing the extracted text or unstructured components of the one or more domain-specific articles and assets into paragraphs, sentences and words to generate one or more domain-specific articles and assets dataset and store in a first database. The one or more domain specific articles and assets (A) is received from one or more external data sources across the world wide web, and (ii) generate a domain-specific semantic model (M) for the enterprise by (a) processing the one or more domain-specific articles and assets dataset received from the first database, and (b) generating the domain-specific semantic model (M), using a machine learning model, based on the one or more domain-specific articles and assets dataset.

In some embodiments, the central semantic model generating unit is configured to (i) transmit the domain-specific semantic model (M) to the information retrieval server that is specific for the enterprise, and (ii) generate an updated domain specific semantic model (M′) by updating the domain specific semantic model, using a model update pipeline, based on one or more updated domain-specific articles and assets (A′) including an addition or deletion of one or more articles and assets received from the first database on periodic intervals, thereafter transmit the updated domain specific semantic model (M′) to execute on the information retrieval server.

In some embodiments, the information retrieval server is configured to (i) tokenize the search query into one or more sentences and one or more words, and (ii) identify whether the search query is related to identifying search results including enterprise knowledge assets or to create a new knowledge asset.

In some embodiments, the information retrieval server is configured to recommend a storyboard for creating the new knowledge asset in response to the search query by (i) identifying a type knowledge asset to create the new knowledge asset if an identified intent of the user is to create the new knowledge asset, (ii) providing the one or more sentences or the one or more words as an input to the one or more enterprise specific semantic models if the identified intent of the user is to create the new knowledge asset, (iii) retrieving relevant enterprise knowledge assets or articles, based on an output from the one or more enterprise specific semantic models, (iv) extracting relevant information snippets from the enterprise knowledge assets or articles that are retrieved, and (v) ordering the extracted information snippets in a sequence flow according to a relevance or a relationship between the extracted information snippets, thereafter providing the information snippets in the sequence flow as the storyboard.

In some embodiments, the information retrieval server is configured to (i) enable the user to edit the information snippets or edit the sequence flow to create the new knowledge asset, (ii) publish the new knowledge asset into a desired document type, and (iii) enable the user to download the new knowledge asset in the desired document type.

In some embodiments, the information retrieval server generates the one or more enterprise-specific semantic models by (i) receiving the domain-specific semantic model (M) from the central semantic model generating unit (ii) receiving the one or more articles and assets within the enterprise from a second database, and (iii) generating the one or more enterprise specific semantic models for one or more organizations by fine tuning the domain specific semantic model (M) with the one or more articles and assets from the enterprise.

In some embodiments, the information retrieval server generates one or more updated enterprise specific semantic models (M_O1′, M_O2′, . . . . M_ON′) by fine tuning the domain specific model (M) or the updated domain specific semantic model (M′) on periodic intervals using one or more enhanced domain-specific articles and assets (A_O1′, A_O2′, . . . . A_ON′) received from a second database.

In some embodiments, the central semantic model generating unit is further configured to update the domain-specific semantic model based on new domain-specific articles and assets across the world wide web.

In one aspect, a method for identifying domain-specific contextual information within an enterprise computing environment to recommend a storyboard for creating a new knowledge asset in response to a search query using a system is provided. The method includes (i) executing, using a first processor of an information retrieval server, one or more enterprise-specific semantic models to identify domain-specific contextual information including one or more domain specific articles and assets within an enterprise computing environment in response to a search query received from a user device. The user device is communicatively connected to the information retrieval server through a network, (ii) pre-processing, using a second processor of a central semantic model generating unit and using a text pre-processor, the one or more domain-specific articles, and assets received from the information retrieval server by (a) extracting text or unstructured components from the plurality of domain-specific articles and assets, and (b) processing the extracted text or unstructured components of the plurality of domain-specific articles and assets into paragraphs, sentences and words to generate one or more domain-specific articles and assets dataset and store in a first database. The one or more domain specific articles and assets (A) is received from one or more external data sources across the world wide web, and (iii) generating, using the second processor of the central semantic model generating unit, a domain-specific semantic model (M) for the enterprise by (a) processing the one or more domain-specific articles and assets dataset received from the first database, and (b) generating the domain-specific semantic model (M), using a machine learning model, based on the one or more domain-specific articles and assets dataset.

In some embodiments, the method further includes (i) transmitting, using the central semantic model generating unit, the domain-specific semantic model (M) that is generated to the information retrieval server that is specific for the enterprise, and (ii) generating, using the central semantic model generating unit, an updated domain specific semantic model (M′) by updating the domain specific semantic model, using a model update pipeline, based on a plurality of updated domain-specific articles and assets (A′) including an addition or deletion of one or more articles and assets received from the first database on periodic intervals, thereafter transmitting the updated domain specific semantic model (M′) to execute on the information retrieval server.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed descriptions with reference to the drawings, in which:

FIG. 1 is a block diagram that illustrates a system for identifying domain-specific contextual information within an enterprise computing environment, according to some embodiments herein;

FIG. 2 is a block diagram that illustrates a central semantic model generating unit of FIG. 1 for generating a domain specific semantic model (M), according to some embodiments herein;

FIG. 3 is a block diagram that illustrates an information retrieval server of FIG. 1 for generating one or more enterprise-specific semantic models, according to some embodiments herein;

FIG. 4 is a block diagram that illustrates an information retrieval server of FIG. 1 for identifying domain-specific contextual information within the enterprise computing environment according to some embodiments herein;

FIG. 5 is a block diagram that illustrates an information retrieval server of FIG. 1 for recommending the storyboard for creating the new knowledge asset, according to some embodiments herein;

FIG. 6 is a flow chart that illustrates a process of generating one or more enterprise specific semantic models, according to some embodiments herein;

FIG. 7 is a flow chart that illustrates a method of identifying domain specific contextual information within an enterprise computing environment, according to some embodiments herein;

FIGS. 8A-8B are flow charts that illustrate a method of recommending a storyboard for creating a new knowledge asset, according to some embodiments herein;

FIG. 9 is a flow diagram that illustrates a method for identifying domain-specific contextual information within an enterprise computing environment to recommend a storyboard for creating a new knowledge asset in response to a search query using a system, according to some embodiments herein; and

FIG. 10 is a schematic diagram of computer architecture of a system or an information retrieval server or a user device or a client device, in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for an improved approach to data accessing related to a specific domain within an enterprise computing environment. Embodiments herein achieve this by providing an artificial intelligence-based system for identifying domain-specific contextual information in an enterprise computing environment. Moreover, embodiments herein further provide a method for identifying domain-specific contextual information within the enterprise computing environment.

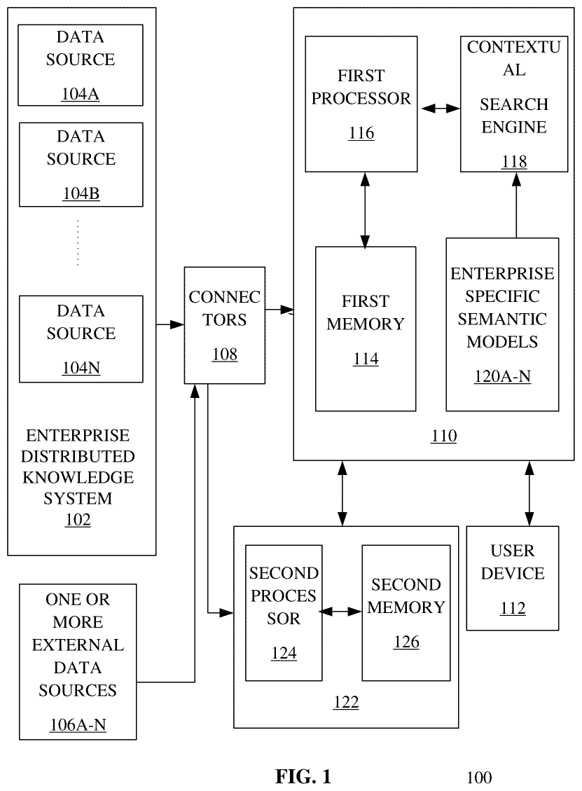

Referring now to the drawings and more particularly to FIGS. 1 through 10, where similar reference characters denote corresponding features consistently throughout the figures, there are shown preferred embodiments.

FIG. 1 is a block diagram that illustrates a system 100 for identifying domain-specific contextual information within an enterprise computing environment, according to some embodiments herein. The system 100 includes an information retrieval server 110, a user device 112, and a central semantic model generating unit 122. The information retrieval server 110 is configured to identify the domain-specific contextual information within the enterprise computing environment in response to a search query that is received from the user device 112. The information retrieval server 110 is further configured to recommend a storyboard for creating a new knowledge asset in response to the search query. The information retrieval server 110 includes a first memory 114 that stores a first set of instructions, a first processor 116 that is configured to execute the first set of instructions to perform the one or more operations of the information retrieval server 110, a contextual search engine 118 and one or more enterprise specific semantic models 120A-N which are used by the contextual search engine 118 to identify the domain specific contextual information within the enterprise computing environment. The central semantic model generating unit 122 is configured to generate a domain-specific semantic model (M) based on one or more domain-specific articles and assets across a world wide web. The central semantic model generating unit 122 includes a second memory 126 that stores a second set of instructions, and a second processor 124 that is configured to execute the second set of instructions to perform the one or more operations of the central semantic model generating unit 122. The central semantic model generating unit 122 may be a server.

The enterprise computing environment includes one or more client devices (not shown in FIG. 1) that are communicatively connected to an enterprise distributed knowledge system 102 directly or indirectly. The enterprise computing environment refers to a collection of computers/machines, storage systems, software, and networks that support the processing and exchange of electronic information in the enterprise. The enterprise may include but is not limited to, a company, an organization, an institution, a firm, an industry, or a corporation. The one or more client devices may include, but are not limited to, a personal computer, a laptop, a tablet device, a smartphone, a mobile communication device, a personal digital assistant, or any computing device. The enterprise distributed knowledge system 102 includes one or more data sources 104A-N that stores one or more knowledge assets of the enterprise. The one or more knowledge assets may be a structured knowledge asset, a semi-structured knowledge asset, or an unstructured knowledge asset. The one or more knowledge assets may be, but are not limited to, any research conducted by human resources, or assets such as presentations, codes, word documents, graphics, any audio information, video information, or any information, etc. created by the human resources for one or more domain-specific functions. The one or more domain-specific functions may include but are not limited to, research, product development, marketing, sales, pre-sales, delivery, administration, safety, or accounts. The one or more data sources 104A-N may include but are not limited to, data storage systems, document management systems, content management systems, content repositories, document repositories, content servers, document servers, or cloud storage systems. The system 100 includes one or more connectors 108 that communicatively connect with the enterprise distributed knowledge system 102 to the information retrieval server 110. The one or more connectors 108 that connect to each knowledge asset or article and each data source 104A-N (data storage systems) that is used by the enterprise, and searches through them to provide search results.

The information retrieval server 110 and the user device 112 are communicatively connected over a network. Similarly, the information retrieval server 110 and the central semantic model generating unit 122 are communicatively connected over the network. Examples of the network may include but are not limited to, a local area network (LAN), a wide area network (WAN), a public network, a private network, a proprietary network, a public telephone switched network (PSTN), the Internet, a wireless network, a virtual network, or any combination thereof. The user device 112 and the one or more client devices in the enterprise computing environment may be the same devices. The user device 112 and the one or more client devices in the enterprise computing environment may be different devices.

The central semantic model generating unit 122 is configured to (i) receive one or more domain specific articles and assets (A) from one or more external data sources 106A-N across the world wide web, (ii) preprocessing, using a text preprocessor, the one or more domain specific articles, and assets by extracting text or unstructured components from the one or more domain-specific articles and assets, and processing the extracted text or unstructured components into paragraphs, sentences, and words to generate one or more domain-specific articles and assets dataset, and (iii) store the processed text and unstructured components of the one or more domain-specific articles and assets in a first database (not shown in FIG. 1). For example, for health care domain, the one or more domain specific articles and assets (A) may be the article “5 Ways to Improve Patient Experience in Healthcare”, and the corresponding asset may be, “The Benefits of Telemedicine”, for finance domain, “the one or more domain specific articles and assets (A) may be the article “Understanding the Basics of Personal Finance”, and the corresponding asset may be, “Interactive Retirement Planning Tool Description”, for education domain, “the one or more domain specific articles and assets (A) may be the article “The Benefits of Project-Based Learning” Description”, and the corresponding asset may be, “Interactive Vocabulary Game Description”.

The central semantic model generating unit 122 is further configured to generate the domain specific semantic model (M) by (i) receiving one or more domain-specific articles and assets dataset from the first database, and (ii) generating the domain-specific semantic model (M), using a machine learning model, based on the one or more domain-specific articles and assets dataset.

The information retrieval server 110 is configured to (i) receive one or more articles and assets from within the enterprise for all N organizations (A_O1, A_O2, . . . . A_ON), (ii) preprocessing, using a text preprocessor, the one or more articles, and assets from the enterprise by converting the one or more articles and assets into a structured form, thereby parsing the one or more articles and assets easily and quickly, and (iii) store the one or more articles and assets in the structured form in organization wise, in a second database (not shown in FIG. 1).

The information retrieval server 110 is further configured to identify one or more attributes associated with the one or more articles and assets within the enterprise and store the one or more attributes in association with the one or more articles and assets in the second database, thereby enabling the identification of asset or article name, an owner, a date of creation, etc. The information retrieval server 110 is further configured to identify newly added files (assets or articles) in the second database and extract and store metadata associated with the newly added files in the second database, thereby improving discoverability and providing advanced filter capabilities to all the assets or articles in the second database.

The information retrieval server 110 is configured to generate the one or more enterprise-specific semantic models 120A-N by (i) receiving the domain-specific semantic model (M) from the central semantic model generating unit 122, (ii) receiving the one or more articles and assets within the enterprise from the second database and (iii) generating the one or more enterprise specific semantic models 120A-N for all N organizations (M_O1, M_O2, . . . . M_ON) by fine-tuning the domain specific semantic model (M) with the one or more articles and assets from the enterprise. The one or more enterprise specific semantic models 120A-N are capable of understanding natural language in one or more specific domains of the enterprise.

The system 100 according to the present disclosure is advantageous in that the system 100 reduces the time to deliver a project (enabling quick turnaround time) by providing the domain specific enterprise knowledge assets or articles, that are similar to a current project, within the enterprise in response to a search query, thereby improving customer experience. For example, project delivery teams write code and create project documents that are reusable across multiple projects. Unfortunately, the created project document is lost or is not discoverable by others in the enterprise. Advantageously, the system 100 enables to discover of such reusable assets, thereby reducing time spent on rework. Further, delivery teams now may have time to work on delivering quality work which in turn improves customer experience and reduces turn-around time.

Similarly, the system 100 reduces the time to learn about a given topic by providing the domain specific enterprise knowledge assets or articles, that are similar to a given, within the enterprise in response to a search query. For example, when human resources are looking to learn a topic, they often end up scanning through the learning and development portal or searching for relevant summarized internal documents. Advantageously, the system 100 puts together all the relevant learning material from across learning and development portals as well as internal knowledge repositories so that the resource can spend more time learning than finding relevant material to learn.

In one exemplary embodiment, the system 100 reduces the time to request proposals (RFP response), thereby increasing wins and revenue. For example, pre-sale consulting teams thrive in chaos. The pre-sale consulting teams are looking to create documents that are required to respond to RFPs. With this system 100, pre-sales consulting teams can surface the most relevant material (that is previously created) within the organization. This reduces rework in a time-constrained situation and provides time for the pre-sales consulting teams to focus on the right aspects of the response. This increases the number of wins and hence revenue.

In another exemplary embodiment, the system 100 reduces the need for repeated knowledge transfer. For example, consulting teams are focused on research, documentation of knowledge, and creation of assets. While research and creation of assets happen in a structured manner, documentation is haphazard. The system 100 can discover and present any documented knowledge from across the enterprise if its relevant to the search query.

In another exemplary embodiment, the system 100 reduces the time to find and build assets while providing the most relevant asset required by prospective customers. For example, sales teams are often trying to find the right asset to respond to customer requirements. Often, they are dependent on project delivery teams to provide them a relevant documents. Also, the document that the salesperson forwards is often a result of their knowledge and a network they have within the enterprise. With the system 100, there are no barriers to finding an asset or an expert who may help the sales teams. Using the system 100, the sales teams may able to find assets in a lesser time as well as find the most relevant assets.

In another exemplary embodiment, the system 100 provides a most relevant set of summarized insights from across the enterprise for competitive intelligence teams. For teams looking for competitive information, the system 100 may be able to provide storyboards from across documents by the project delivery team, consulting teams, and sales teams. This information is usually distributed across customer relationship management (CRM), documentation tools, and document repositories.

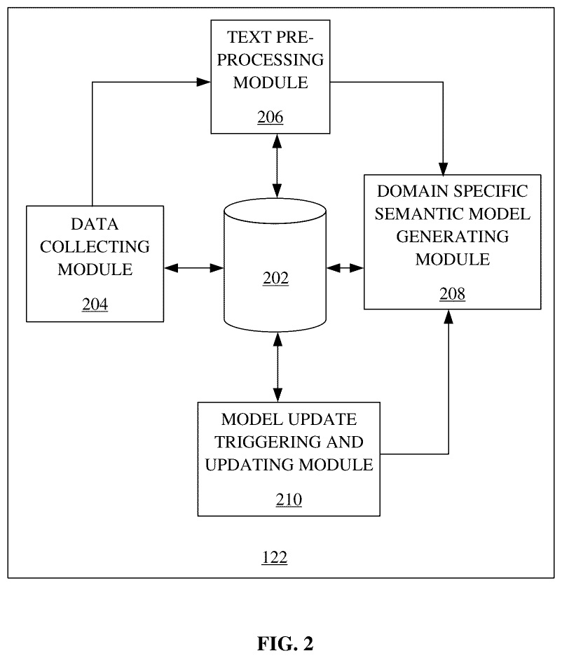

FIG. 2 is a block diagram that illustrates the central semantic model generating unit 122 of FIG. 1 for generating the domain specific semantic model (M), according to some embodiments herein. The central semantic model generating unit 122 includes a database 202, a data collecting module 204, a text-preprocessing module 206, a domain specific semantic model generating module 208, and a model update trigger and updating module 210. The database 202 is communicatively connected with one or more modules of the central semantic model generating unit 122.

The data collecting module 204 is configured to receive, using the one or more connectors 108, the one or more domain specific articles and assets (A) from the one or more external data sources 106A-N across the world wide Web. In some embodiments, the data collecting module 204 is configured to receive new one or more domain specific articles and assets (A) manually from the users. The data collecting module 204 receives the new one or more domain specific articles and assets (A) on periodic intervals.

The text-preprocessing module 206 is configured to preprocess the one or more domain specific articles and assets by extracting text or unstructured components from the one or more domain specific articles and assets and processing the extracted text or unstructured components and storing the processed text and unstructured components of the one or more domain specific articles and assets in the database 202.

In some embodiments, the central semantic model generating unit 122 is configured to transmit the domain-specific semantic model (M) to the information retrieval server 110 which is specific for one or more enterprises. The central semantic model generating unit 122 is further configured to generate an updated domain specific semantic model (M′) by updating the domain specific semantic model, using a model update pipeline, based on enhanced (addition/deletion) articles and assets (A′) from the first database on periodic intervals, thereafter transmits the updated domain specific semantic model (M′) to the information retrieval server 110 on periodic intervals.

In some embodiments, the text or unstructured components from the one or more domain-specific articles and assets are preprocessed using some algorithmic preprocessing that is written in Python using some available Python libraries. Examples of algorithmic preprocessing include tokenization, term frequency, stemming, and lemmatization.

The domain specific semantic model generating module 208 is configured to receive one or more domain specific articles and assets dataset from the database 202 and generate the domain specific semantic model (M), using the machine learning model, based on the one or more domain specific articles and assets dataset.

In some embodiments, the machine learning model comprises Artificial Neural Networks (ANN). The ANN is provided with one or more domain-specific articles and assets as inputs. Based on the inputs, the ANN is trained on the existing words and semantics in the inputs. The ANN is trained with one or more domain-specific articles and assets (e.g., Wikipedia). Once the ANN is trained, it is retrained again. The ANN understands common English terms. Now, articles specific to the domain are added to this input article set. Once the articles are added, retraining of the ANN language model is performed.

The model update trigger and updating module 210 are configured to identify whether newly collected domain specific articles or assets within the database 202 exceed a threshold and update the domain specific model (M) to generate the updated domain specific model (M′) using a new set of articles or assets if the newly collected articles or assets within the database 202 exceeds the threshold. The updating module is a machine learning (ML) logic that is used to update the domain specific model (M) seamlessly.

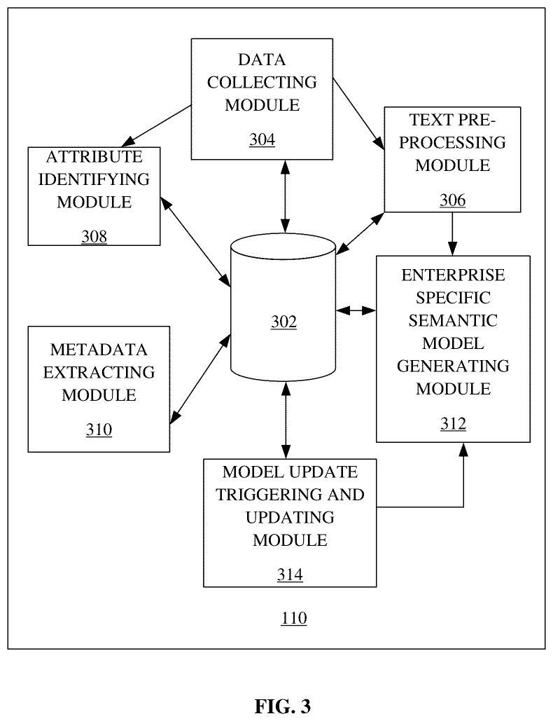

FIG. 3 is a block diagram that illustrates the information retrieval server 110 of FIG. 1 for generating the one or more enterprise-specific semantic models 120A-N, according to some embodiments herein. The information retrieval server 110 includes a database 302, a data collecting module 304, a text-preprocessing module 306, an attribute identifying module 308, a metadata extracting module 310, a domain specific semantic model generating module 312, and a model update trigger and updating module 314. The database 302 is communicatively connected with one or more modules of the information retrieval server 110. The data collecting module 304 is configured to receive, using the one or more connectors 108, the one or more articles and assets from within the enterprise for all N organizations (A_O1, A_O2, . . . . A_ON). The data collecting module 304 receives new one or more enterprise-specific articles and assets (A) from the enterprise on periodic intervals. The text-preprocessing module 306 is further configured to preprocess the one or more articles and assets from the enterprise by converting the one or more articles and assets into a structured form, thereby parsing the one or more articles and assets easily and quickly, and storing the one or more articles and assets in the structured form, in the database 302.

The attribute identifying module 308 is configured to identify the one or more attributes associated with the one or more articles and assets within the enterprise and store the one or more attributes in association with the one or more articles and assets in the database 302, thereby enabling to identify asset or article name, an owner, a date of creation, etc. The metadata extracting module 310 is configured to extract and store metadata associated with the newly added files in the database 302.

The enterprise specific semantic model generating module 312 is configured to (i) receive the domain specific semantic model (M) from the central semantic model generating unit 122, (ii) receive the one or more articles and assets within the enterprise from the database 302, and (iii) generate the one or more enterprise specific semantic models 120A-N for all N organizations (M_O1, M_O2, . . . . M_ON) by fine-tuning the domain specific semantic model with the one or more articles and assets from the enterprise.

The model update trigger and updating module 314 is configured to identify whether newly collected articles or assets from enterprise in the database 302 exceed a threshold and generate the updated the one or more enterprise specific semantic models (M_O1′, M_O2′, . . . . M_ON′) by updating or fine-tuning the one or more enterprise specific semantic models 120A-N using a new set of articles or assets if the newly collected articles or assets within the enterprise exceeds the threshold. The updating module is a machine learning (ML) logic that is used to update the one or more enterprise specific semantic models 120A-N seamlessly.

In some embodiments, the information retrieval server 110 is further configured to generate updated one or more enterprise specific semantic models (M_O1′, M_O2′, . . . M_ON′) by fine tuning the domain specific model (M) or updated domain specific semantic model (M′) on periodic intervals using enhanced (addition/deletion) articles and assets (A_O1′, A_O2′, . . . A_ON′) from the second database. The updating of the domain specific semantic model or the one or more enterprise specific semantic models 120A-N is a continuous process. The domain specific semantic model (M) may be a neural network model that takes an input as a sentence and provides a vector of embeddings that take into consideration a position and sequence of words in an input sentence. The one or more enterprise specific semantic models 120A-N are versions of the domain specific semantic model (M) that is tuned based on enterprise specific assets or articles.

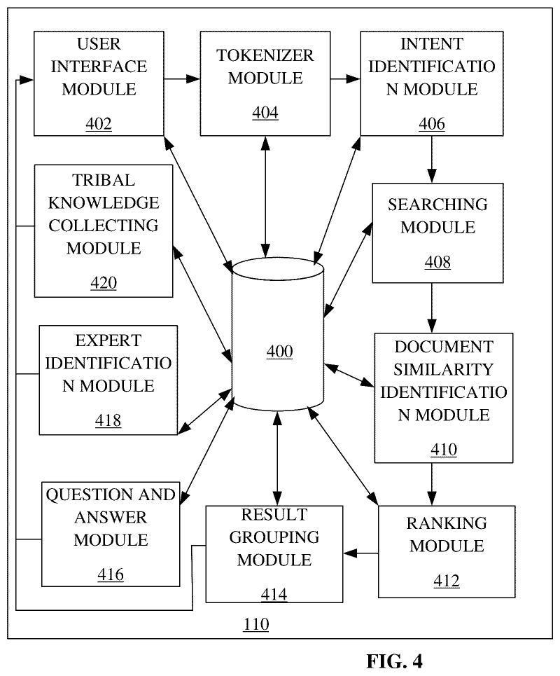

FIG. 4 is a block diagram that illustrates an information retrieval server 110 of FIG. 1 for identifying domain-specific contextual information within the enterprise computing environment, according to some embodiments herein. The information retrieval server 110 includes a database 400, a user interface module 402, a tokenizer module 404, an intent identification module 406, a searching module 408, a document similarity identification module 410, a ranking module 412, a result grouping module 414, a question-and-answer module 416, an expert identification module 418, and a tribal knowledge collecting module 420. The database 400 is communicatively connected with one or more modules of the information retrieval server 110. The database 400 stores the one or more articles and assets within the enterprise for all N organizations.

The user interface module 402 is configured to receive the at least one search query from the user device 112. The at least one search query may be related to the enterprise assets or articles within the enterprise. The user device 112 may include but is not limited to, a personal computer, a laptop, a tablet device, a smartphone, a mobile communication device, a personal digital assistant, or any computing device. The at least one search query is a text-based query. In some embodiments, the at least one search query may include an audio-based query, an audio-video based query, or an image-based query. The user may provide the at least one search query, through an input device of the user device 112. The input device may be a mouse, a keyboard, a microphone, a camera, a touch screen, or a touchpad.

The tokenizer module 404 is configured to tokenize the at least one search query into the one or more sentences (S1, S2, . . . SN) or one or more words (W1, W2, . . . WN). Tokenization is a process of breaking down text in paragraphs into one or more words or one or more sentences. For example, the information retrieval server 110 obtains the at least one search query from a text file and converts the at least one search query into a set of one or more sentences or words. The information retrieval server 110 is configured to provide the one or more sentences or one or more words as an input to the one or more enterprise specific semantic models 120A-N. The one or more enterprise specific semantic models 120A-N are configured to provide the vector of embeddings by considering a position and a sequence of words in the one or more sentences or one or more words.

The intent identification module 406 is configured to identify whether the at least one search query is for identifying search results including enterprise knowledge assets or to create a new knowledge asset.

In some embodiments, the information retrieval server 110 is configured to receive the vector of embeddings from the one or more enterprise specific semantic models 120A-N and provide the vector of embeddings as an input to the contextual search engine 118. The contextual search engine 118 may be a full text search engine. The contextual search engine 118 is configured to (i) perform a search for the knowledge assets or articles in the enterprise, that are related to the at least one search query, in the context of the one or more domains of the enterprise, (ii) identify, using a document similarity algorithm, a list of relevant enterprise knowledge assets or articles from the second database based on the attributes and content of every knowledge assets or articles in the second database, and (iii) rank the list of enterprise knowledge assets or articles based on its relevancy to the at least one search query. The relevant enterprise knowledge assets or articles are the domain specific contextual information. The document similarity algorithm may be K Nearest Neighbor (knn) algorithm or term frequency-inverse document frequency (tf-idf) approach.

In some embodiments, the information retrieval server 110 is further configured to group similar knowledge assets or articles in a search output for providing a diverse set of search outputs based on similarity or a grouping logic. Based on further clicks by users, the information retrieval server 110 updates the search output to the users. The information retrieval server 110 is configured to provide or present the search output on a user interface of the information retrieval server 110 or the user device 112. The user interface may be a display screen.

In some embodiments, the information retrieval server 110 is configured to identify, using an expert matcher, one or more experts within the enterprise for a certain topic when the user unable to find relevant enterprise knowledge assets or articles in the search output. The expert matcher is a machine learning model that is configured to identify the best expert match within the enterprise based on the at least one search query and the experience of the one or more experts.

In some embodiments, the information retrieval server 110 is configured to provide an answer to a question that is posted in the at least one search query.

The searching module 408 is configured to provide the one or more sentences or one or more words as the input to the one or more enterprise specific semantic models 120A-N if the user intends to identify the search results including enterprise knowledge assets. The one or more enterprise specific semantic models 120A-N provide the vector of embeddings by considering a position and a sequence of words in the one or more sentences or one or more words that are received as the input. The searching module 408 is further configured to perform a search for enterprise specific assets or articles in the database 400, that are related to the at least one search query, in the context of the one or more domains of the enterprise.

In some embodiments, the information retrieval server 110 is configured to (i) identify, using an intent identifier, whether the at least one search query is for identifying search results including enterprise knowledge assets or to create a new knowledge asset, (ii) understand what type knowledge asset the user wants to create if the identified intent of the user is to create the new knowledge asset, (iii) retrieve relevant enterprise knowledge assets or articles, using the contextual search engine 118 based on an output from the one or more enterprise specific semantic models 120A-N, (iv) extract relevant information snippets from the retrieved enterprise knowledge assets or articles, (v) order the extracted information snippets in a sequence flow according to a relevance or relationship between the extracted information snippets, thereafter provide the information snippets in the flow as a storyboard (vi) enable the user to edit the information snippets or edit the sequence flow to create the new knowledge asset, (vii) publish the new knowledge asset into a desired document type, and (viii) enable the user to download the new knowledge asset in desired document type. The desired document type may include but is not limited to, a portable document format (PDF), word, excel, a text file, or a PowerPoint.

In some embodiments, the information retrieval server 110 is configured to collect tribal knowledge from across the enterprise or organization. The tribal knowledge refers to undocumented knowledge within the enterprise which is private to a creator or available to a few others only.

In some embodiments, the information retrieval server 110 is configured to provide knowledge insights as alerts to the users (i.e., human resources within enterprise) based on up-to-date knowledge getting accumulated or created in the enterprise

The document similarity identification module 410 is configured to identify the list of relevant enterprise knowledge assets or articles from the database 400 based on the attributes and content of every knowledge asset or article in the database 400. The ranking module 412 is configured to rank the list of enterprise knowledge assets or articles based on their relevancy to the at least one search query. The result grouping module 414 is configured to group similar knowledge assets or articles in the search output for providing a diverse set of search outputs. Based on further clicks by users, the result grouping module 414, updates the search output to the users. The information retrieval server 110 is configured to provide or present the search output on the user interface 402.

The question-and-answer module 416 is configured to provide the answer to the question that is posted in the at least one search query. The expert identification module 418 is configured to identify the one or more experts within the enterprise for a certain topic when the user is unable to find relevant enterprise knowledge assets or articles in the search output, based on the at least one search query and an experience of the one or more experts. The tribal knowledge collecting module 420 is configured to collect the tribal knowledge from across the enterprise or organization. The tribal knowledge refers to undocumented knowledge within the enterprise which is private to a creator or available to a few others only. The information retrieval server 110 further includes a workflow engine that is configured to enable the users to collaborate in terms of seeking information and assets in a structured form. The workflow engine manages and monitors the state of activities in a workflow. Below are a few examples of workflows: 1) raising a request/ticket to ask experts to provide them with the right asset and for the expert to find the right asset, tag it to the request and close it, (ii) raising a request to download an asset, (iii) raising a request to place an asset in a system so that it is discoverable by all users in the future.

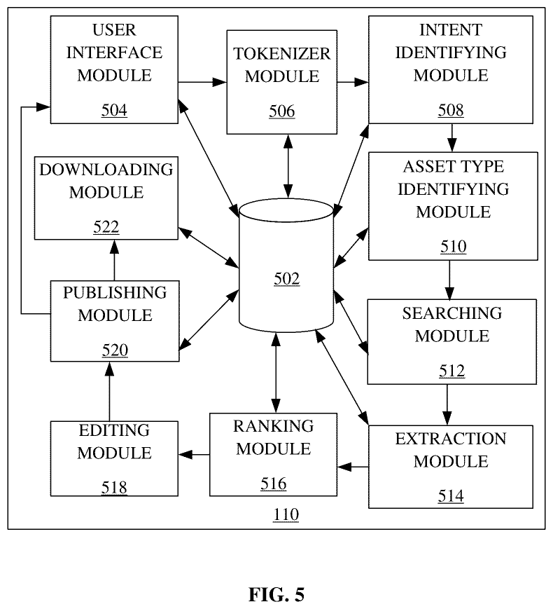

FIG. 5 is a block diagram that illustrates the information retrieval server 110 of FIG. 1 for recommending the storyboard for creating the new knowledge asset, according to some embodiments herein. The information retrieval server 110 includes a database 502, a user interface module 504, a tokenizer module 506, an intent identification module 508, an asset type identification module 510, a searching module 512, an extraction module 514, a ranking module 516, an editing module 518, a publishing module 520, and a downloading module 522. The database 502 is communicatively connected with one or more modules of the information retrieval server 110. The database 502 stores the one or more articles and assets within the enterprise for all N organizations.

The user interface module 504 is configured to receive the at least one search query from the user device 112. The tokenizer module 506 is configured to tokenize the at least one search query into the one or more sentences (S1, S2, . . . SN) or one or more words (W1, W2, . . . WN). The intent identification module 508 is configured to identify whether the at least one search query is for identifying search results including enterprise knowledge assets or to create the new knowledge asset. The asset type identification module 510 is configured to identify what type of knowledge asset the user wants to create if the identified intent of the user is to create the new knowledge asset.

The searching module 512 is configured to provide the one or more sentences or one or more words as the input to the one or more enterprise-specific semantic models 120A-N if the user intends to create the new knowledge asset. The one or more enterprise-specific semantic models 120A-N provide the vector of embeddings by considering a position and a sequence of words in the one or more sentences or one or more words that are received as the input. The searching module 512 is further configured to perform a search for the assets or articles in the enterprise, that are related to the at least one search query, in the context of the one or more domains of the enterprise.

The extraction module 514 is configured to extract relevant information snippets from the retrieved enterprise knowledge assets or articles. The ranking module 516 is configured to order or rank the extracted information snippets in the sequence flow according to the relevance or relationship between the extracted information snippets, thereafter provide the information snippets in the flow as a storyboard. The editing module 518 is configured to enable the user to edit the information snippets or edit the sequence flow to create the new knowledge asset. The publishing module 520 is configured to publish the new knowledge asset into the desired document type on the user interface 504. The downloading module 522 is configured to enable the user to download the new knowledge asset in the desired document type.

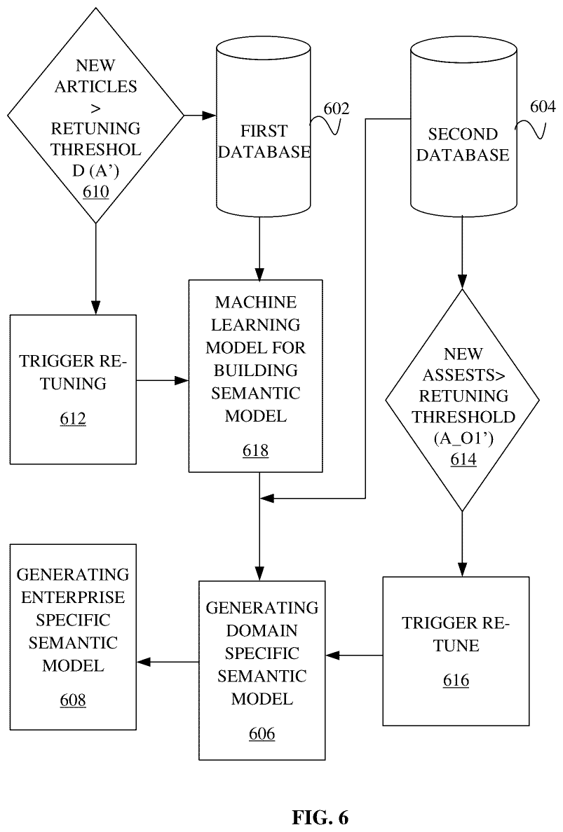

FIG. 6 is a flow chart that illustrates a process of generating the one or more enterprise-specific semantic models 120A-N, according to some embodiments herein. At step 602, preprocessed one or more domain specific articles and assets (A) datasets across the World wide web are stored in a first database. The preprocessed one or more domain-specific articles and assets (A) datasets are generated by extracting text or unstructured components from the one or more domain specific articles and assets (A) and processing the extracted text or unstructured components. The first database may be the NoSQL database. The one or more domain specific articles and assets (A) datasets are used as an input to build the domain specific semantic model (M). The one or more domain specific articles and assets (A) ensure that the domain semantic model (M) understands the natural language of the domain. The collection of one or more domain specific articles and assets (A) is enhanced over time in the first database.

At step 604, preprocessed one or more enterprise articles and assets are stored in the second database. The preprocessed one or more enterprise articles and assets are generated by (i) receiving one or more articles and assets from within the enterprise for all N organizations (A_O1, A_O2, . . . A_ON), and (ii) preprocessing the one or more articles and assets from the enterprise by converting the one or more articles and assets into the structured form. One or more attributes and metadata associated with the enterprises'assets or articles are stored in the second database. The second database may be full text NoSQL database. The one or more enterprise articles and assets are a collection of all knowledge assets or articles of the enterprise. The one or more enterprise articles and assets are used to fine-tune the domain-specific semantic model further to understand the natural language of the enterprise. This approach helps the system 100 to understand enterprise specific terminology and jargon.

At step 606, the domain specific semantic model (M), using a machine learning model 618, is generated based on the one or more domain specific articles and assets datasets from the first database. The domain specific semantic model (M) may be a neural network model that takes an input as a sentence (search query) and provides a vector of embeddings by considering a position and sequence of words in the input sentence. At step 608, one or more enterprise specific semantic models 120A-N for all N organizations are generated by fine tuning the domain specific semantic model (M) with the preprocessed one or more enterprise articles and assets from the second database. The one or more enterprise specific semantic models 120A-N are capable of understanding natural language of one or more specific domains of the enterprise.

At step 610, it is checked whether the new assets or articles in the first database exceeds a retuning threshold value or not. At step 612, a trigger for retuning the domain specific semantic model (M) is initiated if the new assets or articles in the first database exceeded the retuning threshold value. Then, the machine learning model 618 generates the updated domain specific semantic model (M′) by updating the domain specific semantic model (M), based on the new assets or articles from the first database on periodic intervals. At step 614, it is checked whether the new assets or articles in the second database exceed a retuning threshold value or not. At step 616, the trigger for retuning the one or more enterprise specific semantic models 120A-N is initiated if the new assets or articles in the second database exceeded the retuning threshold value. Then, the machine learning model 618 generates an updated one or more enterprise specific semantic models by updating the one or more enterprise specific semantic models 120A-N or the domain specific semantic model (M) or the updated domain specific semantic model (M′), based on the new assets or articles from the second database on periodic intervals.

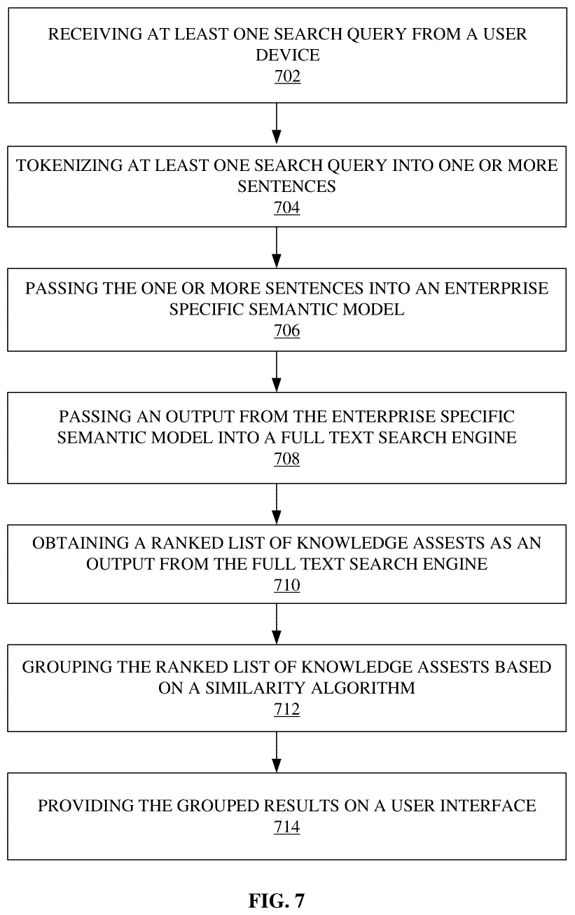

FIG. 7 is a flow chart that illustrates a method of identifying domain specific contextual information within an enterprise computing environment, according to some embodiments herein. At step 702, at least one search query from the user device 112 is received. At step 704, the at least one search query is tokenized into the one or more sentences (S1, S2, . . . SN) or one or more words (W1, W2, . . . WN). At step 706, the one or more sentences (S1, S2, . . . SN) or one or more words are passed to the one or more one or more enterprise specific semantic models 120A-N. The one or more enterprise specific semantic models 120A-N provide the vector of embeddings as an output by considering a position and a sequence of words in the one or more sentences or one or more words that are received as the input. At step 708, the output from the one or more enterprise specific semantic models 120A-N is provided to a full text search engine. The full text search engine performs a search for the assets or articles in the enterprise, that are related to the at least one search query, in a context of the one or more domains of the enterprise and identifies the list of relevant enterprise knowledge assets or articles within the enterprise based on the attributes and content of every knowledge asset or articles. At step 710, a list of relevant enterprise knowledge assets or articles is ranked based on its relevancy to the at least one search query. At step 712, similar knowledge assets or articles in the search output are grouped for providing a diverse set of search outputs. At step 714, the search output or grouped results are provided or presented on a user interface.

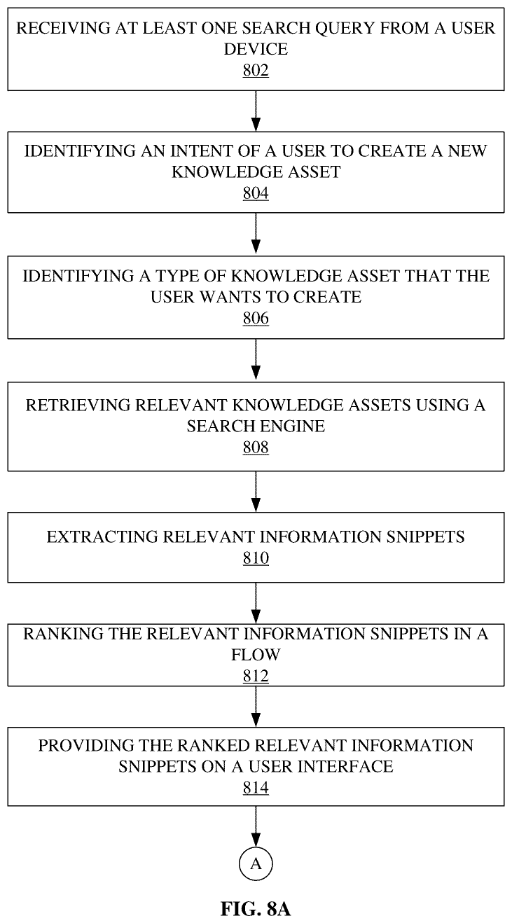

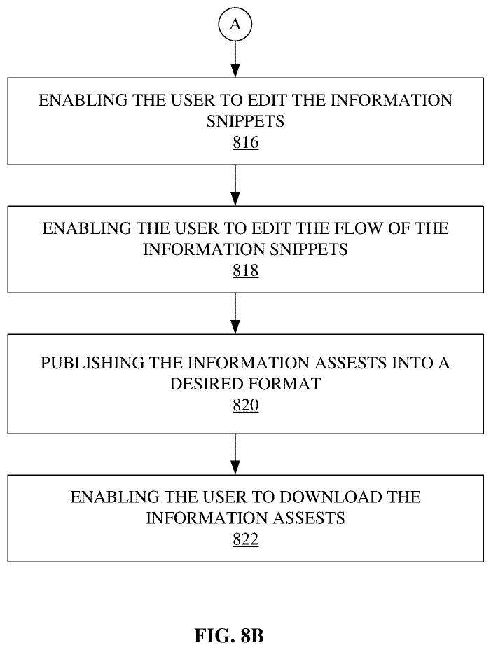

FIGS. 8A-8B are flow charts that illustrate a method of recommending a storyboard for creating a new knowledge asset, according to some embodiments herein. At step 802, at least one search query from the user device 112 is received. At step 804, an intent of a user to create a new knowledge asset is identified. At step 806, a type of knowledge asset that the user wants to create is identified. At step 808, a list of relevant knowledge assets within the enterprise is identified using a search engine. At step 810, relevant information snippets from the list of relevant knowledge assets are extracted. At step 812, the extracted information snippets are ranked or ordered in a sequence flow according to the relevance or relationship between the extracted information snippets. At step 814, providing the ranked information snippets in the flow as a storyboard on a user interface. At step 816, it is enabled to edit the information snippets by the user if needed. At step 818, it is enabled to edit the flow of the information snippets by the user if needed. At step 820, the information snippets are published in a desired document type on the user interface. At step 822, it is enabled to download the published information snippets which are in the desired document type.

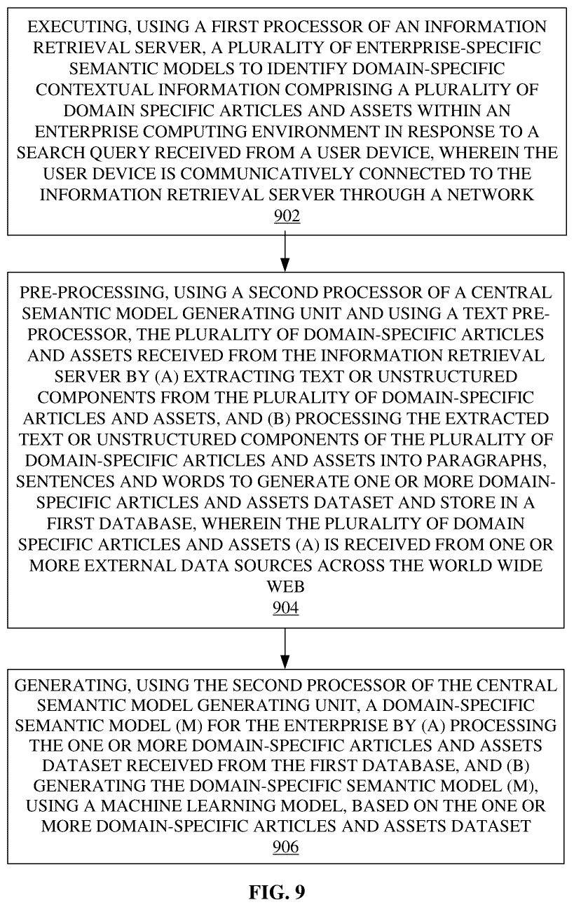

FIG. 9 is a flow diagram that illustrates a method for identifying domain-specific contextual information within an enterprise computing environment to recommend a storyboard for creating a new knowledge asset in response to a search query using a system, according to some embodiments herein. At step 902, one or more enterprise-specific semantic models 120A-N are executed, using a first processor 116 of an information retrieval server 110, to identify domain-specific contextual information including one or more domain specific articles and assets within an enterprise computing environment in response to a search query received from a user device 112. The user device 112 is communicatively connected to the information retrieval server 110 through a network. At step 904, the one or more domain-specific articles and assets received from the information retrieval server 110 are pre-processed, using a second processor 124 of a central semantic model generating unit 122 and using a text pre-processor, by (a) extracting text or unstructured components from the one or more domain-specific articles and assets, and (b) processing the extracted text or unstructured components of the one or more domain-specific articles and assets into paragraphs, sentences, and words to generate one or more domain-specific articles and assets dataset and store in a first database. The one or more domain specific articles and assets (A) are received from one or more external data sources 106A-N across the world wide web. At step 906, a domain-specific semantic model M for the enterprise is generated, using the second processor 124 of the central semantic model generating unit 122, by (a) processing the one or more domain-specific articles and assets dataset received from the first database, and (b) generating the domain-specific semantic model (M), using a machine learning model, based on the one or more domain-specific articles and assets dataset.

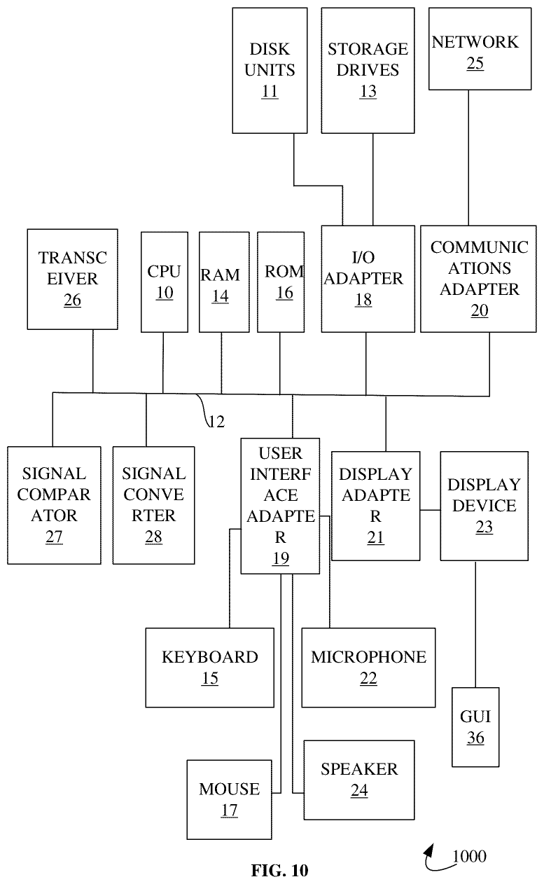

A representative hardware environment for practicing the embodiments herein is depicted in FIG. 10 with reference to FIGS. 1 through 9. This schematic drawing illustrates a hardware configuration of system or an information retrieval server or a user device or a client device or a central semantic model generating system, in accordance with the embodiments herein. The hardware configuration includes at least one processing device and a cryptographic processor 10. The system 1000 may include one or more of a personal computer, a laptop, a tablet device, a smartphone, a mobile communication device, a personal digital assistant, or any other such computing device, in one example embodiment. The system 1000 includes one or more processor (e.g., the processor 104) or central processing unit (CPU) 10. The CPUs 10 are interconnected via system bus 12 to various devices such as a random-access memory (RAM) 14, read-only memory (ROM) 16, and an input/output (I/O) adapter 18. Although, CPUs 10 are depicted, it is to be understood that the system 1000 may be implemented with only one CPU.

The I/O adapter 18 can connect to peripheral devices, such as disk units 11 and storage drives 13 (tape drives), or other program storage devices that are readable by the system. The system 1000 can read the inventive instructions on the program storage devices and follow these instructions to execute the methodology of the embodiments herein. The system 1000 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a network 25, and a display adapter 21 connects the bus 12 to a display device 23, which provides a graphical entity interface (GUI) 36 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric signals.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing or executing program code will include at least one processor coupled directly or indirectly to memory elements through a system bus. The memory elements can include local memory employed during actual execution of the program code, bulk storage, Subscriber Identity Module (SIM) card, and cache memories which provide temporary storage of at least some program code in order to reduce the number of times code must be retrieved from bulk storage during execution. Input/output (I/O) devices (including but not limited to keyboards, displays, pointing devices, remote controls, camera, microphone, temperature sensor, accelerometer, gyroscope, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of employed herein is for the purpose of description and not of limitation. Therefore, while the embodiments herein have been described in terms of preferred embodiments, those skilled in the art will recognize that the embodiments herein can be practiced with modification within the scope of the appended claims.

What is claimed is:

1. A system for identifying domain-specific contextual information within an enterprise computing environment to recommend a storyboard for creating a new knowledge asset in response to a search query, comprising:
an information retrieval server comprising:
a first memory; and
a first processor that executes a plurality of enterprise-specific semantic models to identify domain-specific contextual information comprising a plurality of domain specific articles and assets within an enterprise computing environment in response to a search query received from a user device, wherein the user device is communicatively connected to the information retrieval server through a network; and
a central semantic model generating unit that is communicatively connected to the information retrieval server through a network, comprising,
a second memory; and
a second processor that is configured to (i) pre-process, using a text pre-processor, the plurality of domain-specific articles and assets received from the information retrieval server by (a) extracting text or unstructured components from the plurality of domain-specific articles and assets, and (b) processing the extracted text or unstructured components of the plurality of domain-specific articles and assets into paragraphs, sentences, and words to generate one or more domain-specific articles and assets dataset and store in a first database, wherein the plurality of domain specific articles and assets (A) is received from one or more external data sources across the world wide web; and
characterized in that (ii) generate a domain-specific semantic model (M) for the enterprise by (a) processing the one or more domain-specific articles and assets dataset received from the first database, and (b) generating the domain-specific semantic model (M), using a machine learning model, based on the one or more domain-specific articles and assets dataset.

2. The system of claim 1, wherein central semantic model generating unit is configured to
(i) transmit the domain-specific semantic model (M) to the information retrieval server that is specific for the enterprise; and
(ii) generate an updated domain specific semantic model (M′) by updating the domain specific semantic model, using a model update pipeline, based on a plurality of updated domain-specific articles and assets (A′) comprising an addition or deletion of one or more articles and assets received from the first database on periodic intervals, thereafter transmit the updated domain specific semantic model (M′) to execute on the information retrieval server.

3. The system of claim 1, wherein the information retrieval server is configured to tokenize the search query into one or more sentences and one or more words; and identify whether the search query is related to identifying search results including enterprise knowledge assets or to create a new knowledge asset.

4. The system of claim 3, wherein the information retrieval server is configured to recommend a storyboard for creating the new knowledge asset in response to the search query by
(i) identifying a type knowledge asset to create the new knowledge asset if an identified intent of the user is to create the new knowledge asset;
(ii) providing the one or more sentences or the one or more words as an input to the plurality of enterprise specific semantic models if the identified intent of the user is to create the new knowledge asset;
(iii) retrieving relevant enterprise knowledge assets or articles, based on an output from the plurality of enterprise specific semantic models;
(iv) extracting relevant information snippets from the enterprise knowledge assets or articles that are retrieved; and
(v) ordering the extracted information snippets in a sequence flow according to a relevance or a relationship between the extracted information snippets, thereafter providing the information snippets in the sequence flow as the storyboard.

5. The system of claim 4, wherein the information retrieval server is configured to
(i) enable the user to edit the information snippets or edit the sequence flow to create the new knowledge asset;
(ii) publish the new knowledge asset into a desired document type, and
(iii) enable the user to download the new knowledge asset in the desired document type.

6. The system of claim 1, wherein the information retrieval server generates the plurality of enterprise-specific semantic models by (i) receiving the domain-specific semantic model (M) from the central semantic model generating unit (ii) receiving the one or more articles and assets within the enterprise from a second database, and (iii) generating the plurality of enterprise specific semantic models for a plurality of organizations by fine tuning the domain specific semantic model (M) with the one or more articles and assets from the enterprise.

7. The system of claim 6, wherein the information retrieval server generates a plurality of updated enterprise specific semantic models (M_O1′, M_O2′, . . . M_ON′) by fine tuning the domain specific model (M) or the updated domain specific semantic model (M′) on periodic intervals using a plurality of enhanced domain-specific articles and assets (A_O1′,A_O2′, . . . A_ON′) received from a second database.

8. The system of claim 1, wherein the central semantic model generating unit is further configured to update the domain-specific semantic model based on new domain-specific articles and assets across the world wide web.

9. A method for identifying domain-specific contextual information within an enterprise computing environment to recommend a storyboard for creating a new knowledge asset in response to a search query using a system, comprising:
executing, using a first processor of an information retrieval server, a plurality of enterprise-specific semantic models to identify domain-specific contextual information comprising a plurality of domain specific articles and assets within an enterprise computing environment in response to a search query received from a user device, wherein the user device is communicatively connected to the information retrieval server through a network;
pre-processing, using a second processor of a central semantic model generating unit and using a text pre-processor, the plurality of domain-specific articles and assets received from the information retrieval server by (a) extracting text or unstructured components from the plurality of domain-specific articles and assets, and (b) processing the extracted text or unstructured components of the plurality of domain-specific articles and assets into paragraphs, sentences and words to generate one or more domain-specific articles and assets dataset and store in a first database, wherein the plurality of domain specific articles and assets (A) is received from one or more external data sources across the world wide web; and
characterized in that,
generating, using the second processor of the central semantic model generating unit, a domain-specific semantic model (M) for the enterprise by (a) processing the one or more domain-specific articles and assets dataset received from the first database, and (b) generating the domain-specific semantic model (M), using a machine learning model, based on the one or more domain-specific articles and assets dataset.

10. The method of claim 9, further comprising:
transmitting, using the central semantic model generating unit, the domain-specific semantic model (M) that is generated to the information retrieval server that is specific for the enterprise; and
generating, using the central semantic model generating unit, an updated domain specific semantic model (M′) by updating the domain specific semantic model, using a model update pipeline, based on a plurality of updated domain-specific articles and assets (A′) comprising an addition or deletion of one or more articles and assets received from the first database on periodic intervals, thereafter transmitting the updated domain specific semantic model (M′) to execute on the information retrieval server.
